(19) United States
(12) Patent Application Publication
(10) Pub. No.: US 2026/0018357 A1
(43) Pub. Date: Jan. 15, 2026

(54) DRIVE POWER SUPPLY FOR MECHANICAL SWITCH, POWER SUPPLY DEVICE, AND METHOD FOR DIAGNOSING DEGRADATION

(71) Applicant: TMEIC Corporation, Tokyo (JP)

(72) Inventors: Tatsuya TAKAMI, Chuo-ku (JP); Keisuke OHNISHI, Chuo-ku (JP); Xiaochen ZHANG, Chuo-ku (JP)

(73) Assignee: TMEIC Corporation, Tokyo (JP)

(21) Appl. No.: 18/993,635

(22) PCT Filed: Jun. 14, 2023
(86) PCT No.: PCT/JP2023/022063

§ 371 Date: Jan. 13, 2025

(51) Int. Cl. H01H 71/04; H01H 33/28; H01H 47/00; H02M 3/335

(52) U.S. Cl. CPC H01H 71/04; H01H 33/28; H01H 47/001; H02M 3/33584; H01H 2071/044

(57) ABSTRACT

A mechanical switch includes a mechanical contact, and a coil that receives supply of a drive current from a drive power supply and opens or closes the mechanical contact. The drive power supply includes a capacitor, and a switch connected between the capacitor and the coil. The switch is temporarily turned on in order to turn on/off the mechanical switch, and supplies the drive current from the capacitor to the coil. The drive power supply further includes a charging circuit that charges the capacitor in an OFF period of the switch, a detection circuit that detects a charging current and a voltage of the capacitor, and a diagnosis circuit that diagnoses a degradation state of the capacitor from the detected charging current and voltage.

### TECHNICAL FIELD

The present disclosure relates to a drive power supply for a mechanical switch, a power supply device, and a method for diagnosing degradation of a capacitor included in a drive power supply for a mechanical switch.

### BACKGROUND ART

Japanese Patent Laying-Open No. 2013-50351 (PTL 1) discloses a device for diagnosing degradation of an electric double layer capacitor used for a power supply device such as a multiple power compensator.

The device for diagnosing degradation disclosed in PTL 1 includes a discharging circuit in which a sinusoidal load circuit is connected to a charged electric double layer capacitor to provide a sinusoidal load to discharge the electric double layer capacitor, a current detection circuit that detects a current flowing to the discharging circuit, a voltage detection circuit that measures a voltage of the electric double layer capacitor during discharging via the discharging circuit, and a computation unit that calculates an impedance of the electric double layer capacitor using the current detected by the current detection circuit and the voltage detected by the voltage detection circuit.

### CITATION LIST

### Patent Literature

PTL 1: Japanese Patent Laying-Open No. 2013-50351

### SUMMARY OF INVENTION

### Technical Problem

In the device for diagnosing degradation described above, it is necessary to connect the discharging circuit having the sinusoidal load circuit to the electric double layer capacitor. Further, it is necessary to provide sensors for detecting the current flowing to the discharging circuit and the voltage of the electric double layer capacitor during discharging, and a computation element that performs computation processing of detection values of these sensors. Accordingly, there is a concern that mounting the device for diagnosing degradation on the power supply device may upsize the power supply device. Further, there is a concern that upsizing of the power supply device may cause a cost increase.

The present disclosure has been made in view of the aforementioned problem, and an object thereof is to provide a drive power supply for a mechanical switch, a power supply device, and a method for diagnosing degradation capable of diagnosing a degradation state of a capacitor with a downsized configuration.

### Solution to Problem

A drive power supply in accordance with one aspect of the present disclosure supplies a drive current to a mechanical switch. The mechanical switch includes a mechanical contact, and a coil that receives supply of the drive current and opens or closes the mechanical contact. The drive power supply includes a capacitor, and a switch connected between the capacitor and the coil. The switch is configured to be temporarily turned on in order to turn on or off the mechanical switch, and to supply the drive current from the capacitor to the coil. The drive power supply further includes a charging circuit that charges the capacitor in an OFF period of the switch, a detection circuit that detects a charging current and a voltage of the capacitor, and a diagnosis circuit that diagnoses a degradation state of the capacitor from the charging current and the voltage detected by the detection circuit.

A method for diagnosing degradation in accordance with one aspect of the present disclosure is a method for diagnosing degradation of a capacitor included in a drive power supply that supplies a drive current to a mechanical switch. The mechanical switch includes a mechanical contact, and a coil that receives supply of the drive current and opens or closes the mechanical contact. The drive power supply includes a capacitor, and a switch connected between the capacitor and the coil, and is configured to temporarily turn on the switch in order to turn on or off the mechanical switch, and to supply the drive current from the capacitor to the coil. The method for diagnosing degradation includes charging the capacitor in an OFF period of the switch, detecting a charging current and a voltage of the capacitor, and diagnosing a degradation state of the capacitor from the charging current and the voltage.

### Advantageous Effects of Invention

According to the present disclosure, the degradation state of the capacitor can be diagnosed from the charging current and the voltage of the capacitor, utilizing the charging circuit for the capacitor mounted on the drive power supply for the mechanical switch. Accordingly, it is not necessary to mount a dedicated degradation diagnosis device, and the degradation state of the capacitor can be diagnosed with a downsized configuration.

### BRIEF DESCRIPTION OF DRAWINGS

FIG. 1 is a view showing a configuration of a power supply device to which a drive power supply for a mechanical switch in accordance with a first embodiment is applied.

FIG. 2 is a view showing an exemplary hardware configuration of a controller.

FIG. 3 is a view showing an exemplary configuration of the drive power supply in accordance with the first embodiment.

FIG. 4 is a circuit diagram showing an exemplary circuit configuration of drive circuits and a charging circuit shown in FIG. 3.

FIG. 5 is a view for describing operation of the drive power supply.

FIG. 6 is a view for describing a first example of processing for diagnosing degradation of a capacitor in a diagnosis circuit.

FIG. 7 is a flowchart showing the processing for diagnosing degradation of a capacitor in the drive power supply in accordance with the first embodiment.

FIG. 8 is a flowchart showing processing for diagnosing degradation of a capacitor in a drive power supply in accordance with a second embodiment.

FIG. 9 is a view for describing a second example of the processing for diagnosing degradation of a capacitor in the diagnosis circuit.

### DESCRIPTION OF EMBODIMENTS

Embodiments of the present disclosure will be described in detail with reference to the drawings. It should be noted that identical or corresponding parts in the drawings will be designated by the same reference numerals, and the description thereof will not be repeated.

### First Embodiment

### <Configuration of Power Supply Device>

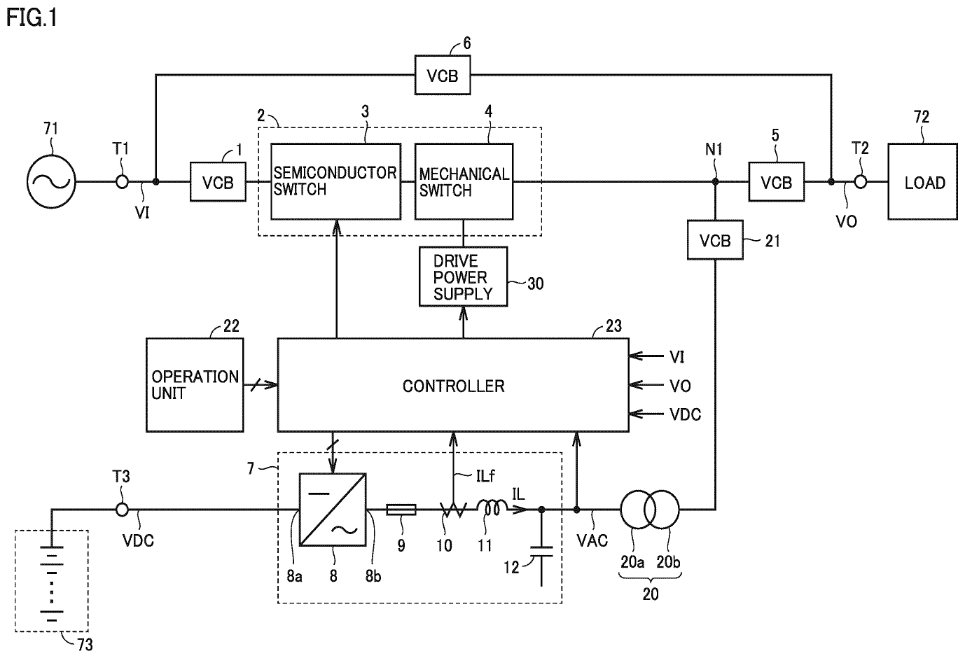

FIG. 1 is a view showing a configuration of a power supply device to which a drive power supply for a mechanical switch in accordance with a first embodiment is applied. FIG. 1 describes a multiple power compensator as an example of the power supply device.

As shown in FIG. 1, the multiple power compensator includes an input terminal T1, an output terminal T2, a direct current (DC) terminal T3, vacuum circuit breakers (VCBs) 1, 5, 6, and 21, a high-speed switch 2, a power converter 7, a transformer 20, an operation unit 22, a controller 23, and a drive power supply 30.

Input terminal T1 receives an alternating current (AC) voltage VI having a commercial frequency supplied from a commercial AC power supply 71. An instantaneous value of AC voltage VI is detected by controller 23. When AC voltage VI falls below a lower limit value, controller 23 determines that a momentary voltage drop occurs.

Output terminal T2 is connected to a load 72. Load 72 is driven by an AC voltage VO supplied from output terminal T2. An instantaneous value of AC voltage VO is detected by controller 23.

DC terminal T3 is connected to a power storage device 73. Power storage

device 73 stores DC power. Power storage device 73 may be a battery, or may be a capacitor. A DC voltage VDC of DC terminal T3 is detected by controller 23.

VCB 1, high-speed switch 2, and VCB 5 are connected in series between input terminal T1 and output terminal T2. VCBs 1 and 5 are turned on during normal operation of the multiple power compensator, and are turned off during maintenance of high-speed switch 2 or during bypass power feeding, for example.

High-speed switch 2 includes a semiconductor switch 3 and a mechanical switch 4 connected in series. Semiconductor switch 3 is controlled by controller 23, is turned on when AC voltage VI is normal, and is turned off when AC voltage VI is not normal (when a momentary voltage drop occurs).

Mechanical switch 4 is driven by drive power supply 30. Drive power supply 30 is controlled by controller 23, drives mechanical switch 4 to an ON state when AC voltage VI is normal, and drives mechanical switch 4 to an OFF state when AC voltage VI is not normal (when a momentary voltage drop occurs).

Semiconductor switch 3 has a characteristic that its operation speed is faster and its withstand voltage is lower when compared with mechanical switch 4. Mechanical switch 4 has a characteristic that its operation speed is slower and its withstand voltage is higher when compared with semiconductor switch 3. Semiconductor switch 3 and mechanical switch 4 are connected in series to constitute high-speed switch 2, which is instantaneously turned off when a momentary voltage drop occurs, and has a high withstand voltage.

VCB 6 is connected between input terminal T1 and output terminal T2. VCB 6 is turned off during normal operation of the multiple power compensator, and is turned on during bypass power feeding, for example. When VCB 6 is turned on, AC voltage VI is supplied from commercial AC power supply 71 to load 72 via VCB 6, and load 72 is operated.

Power converter 7 includes a bidirectional converter 8, a fuse 9, a current detector 10, a reactor 11, and a capacitor 12. Bidirectional converter 8 has a DC terminal 8a connected to DC terminal T3, and an AC terminal 8b connected to a primary winding 20a of transformer 20 via fuse 9 and reactor 11. A secondary winding 20b of transformer 20 is connected via VCB 21 to a node N1 between high-speed switch 2 and VCB 5. An instantaneous value of an AC voltage VAC appearing at primary winding 20a of transformer 20 is detected by controller 23.

Bidirectional converter 8 is a well-known bidirectional converter including a plurality of semiconductor switching elements and a plurality of diodes, and is pulse width modulation (PWM)-controlled by controller 23, for example. By turning on and off each semiconductor switching element included in bidirectional converter 8 at a predetermined frequency, AC power can be converted into DC power, and conversely, DC power can be converted into AC power.

When AC voltage VI supplied from commercial AC power supply 71 is normal, bidirectional converter 8 converts AC power supplied from commercial AC power supply 71 via VCB 1, high-speed switch 2, VCB 21, transformer 20, reactor 1N21, and fuse 9, into DC power, and stores it in power storage device 73.

Further, when AC voltage VI is not normal, bidirectional converter 8 converts the DC power in power storage device 73 into AC power, and outputs it to AC terminal 8b. The AC power is supplied to load 72 via fuse 9, reactor 11, transformer 20, and VCBs 21 and 5.

Fuse 9 protects bidirectional converter 8 from an overcurrent. Current detector 10 detects a current IL flowing to reactor 11, and provides controller 23 with a signal ILf indicating a detection value thereof.

Reactor 11 and capacitor 12 constitute an AC filter. The AC filter is a low pass filter, which passes a current having the commercial frequency and cuts off a current having a switching frequency generated in bidirectional converter 8. In other words, the AC filter converts an output voltage of bidirectional converter 8 into sinusoidal AC voltage VAC.

Transformer 20 transmits and receives AC power between node N1 and power converter 7. VCB 21 is turned on during normal operation of the multiple power compensator, and is turned off during maintenance of high-speed switch 2 or power converter 7, for example.

Operation unit 22 includes a plurality of buttons, a plurality of switches, a display, and the like. Through operating operation unit 22, a user of the multiple power compensator can instruct start, stop, automatic operation, manual operation, and the like of the multiple power compensator, and can set various conditions and the like. Operation unit 22 provides controller 23 with a signal indicating the user's instruction or the like.

Controller 23 controls the entire multiple power compensator based on the signal from operation unit 22, AC voltages VI, VO, and VAC, DC voltage VDC, output signal ILf of current detector 10, and the like.

When AC voltage VI supplied from commercial AC power supply 71 is normal, controller 23 controls bidirectional converter 8 such that DC voltage VDC of DC terminal T3 becomes equal to a predetermined reference DC voltage VDCr, based on AC voltage VAC, DC voltage VDC, and output signal ILf of current detector 10.

When AC voltage VI supplied from commercial AC power supply 71 is not normal, controller 23 controls bidirectional converter 8 such that AC voltage VO of output terminal T2 becomes equal to a predetermined reference AC voltage VOr.

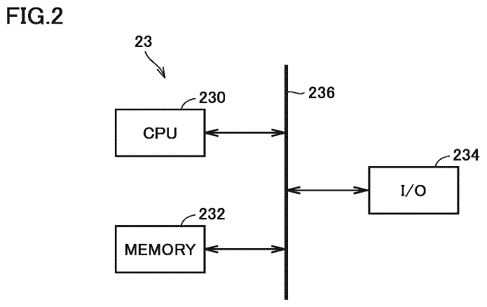

FIG. 2 is a view showing an exemplary hardware configuration of controller 23. Typically, controller 23 can be configured by a microcomputer in which predetermined programs are stored beforehand.

For example, as shown in FIG. 2, controller 23 is configured to include a central processing unit (CPU) 230, a memory 232, and an input/output (I/O) circuit 234. CPU 230, memory 232, and I/O) circuit 234 can exchange data with one another through a bus 236. Programs are stored beforehand in a partial area of memory 232, and various functions can be implemented when CPU 230 executes the programs.

Alternatively, unlike the example in FIG. 2, at least a portion of controller 23 can be configured using a circuit such as a field programmable gate array (FPGA) or an application specific integrated circuit (ASIC). Further, at least a portion of controller 23 can also be configured by an analog circuit.

Turning back to FIG. 1, drive power supply 30 is controlled by controller 23 to drive mechanical switch 4. Drive power supply 30 is equipped with a capacitor that stores DC power, and uses the power stored in the capacitor to turn on mechanical switch 4 when AC voltage VI is normal, and turn off mechanical switch 4 when AC voltage VI is not normal.

In order to instantaneously turn off mechanical switch 4 when a momentary voltage drop occurs in commercial AC power supply 71 to secure supply of power to load 72, the capacitor is required to have a high reliability. Accordingly, it is necessary to diagnose a degradation state of the capacitor, and to take measures such as replacing the capacitor when it is diagnosed that the degradation state is proceeding.

In the present embodiment, drive power supply 30 is configured to diagnose the degradation state of the capacitor in parallel to driving mechanical switch 4. More specifically, drive power supply 30 has a charging circuit for charging DC power to the capacitor, and is configured to diagnose the degradation state of the capacitor during charging of the capacitor by the charging circuit. Since diagnosis of degradation of the capacitor is conducted utilizing the already provided charging circuit as described above, it is not necessary to mount a dedicated degradation diagnosis device on the multiple power compensator. Therefore, the degradation state of the capacitor can be diagnosed with a downsized configuration.

### <Configuration of Drive Power Supply>

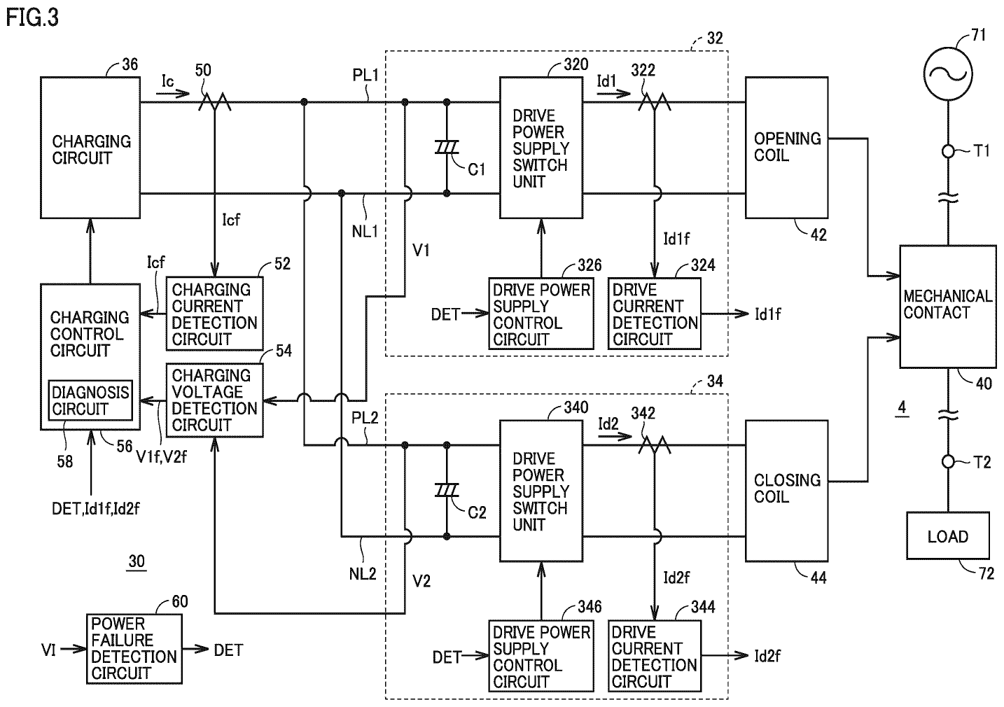

FIG. 3 is a view showing an exemplary configuration of drive power supply 30 in accordance with the first embodiment. As shown in FIG. 3, drive power supply 30 is configured to supply a drive current to mechanical switch 4.

Mechanical switch 4 includes a mechanical contact 40, and coils 42 and 44 that open or close mechanical contact 40. Mechanical contact 40 is formed using an elastic material such as a spring.

Coil 42 receives supply of a drive current Id1 from drive power supply 30, converts electrical energy into mechanical energy, and thereby opens mechanical contact 40. By opening mechanical contact 40, mechanical switch 4 is turned off, and energization to mechanical switch 4 is stopped (mechanical switch 4 is opened). In the following description, coil 42 will also be referred to as an “opening coil” for turning off mechanical switch 4.

Coil 44 receives supply of a drive current Id2 from drive power supply 30, converts electrical energy into mechanical energy, and thereby closes mechanical contact 40. By closing mechanical contact 40, mechanical switch 4 is turned on, and energization to mechanical switch 4 is started (mechanical switch 4 is closed). In the following description, coil 42 will also be referred to as a “closing coil” for turning on mechanical switch 4.

Drive power supply 30 includes drive circuits 32 and 34, a charging circuit 36, a current detector 50, a charging current detection circuit 52, a charging voltage detection circuit 54, a charging control circuit 56, and a power failure detection circuit 60.

Drive circuit 32 is a circuit for supplying drive current Id1 to opening coil 42. Drive circuit 32 includes a capacitor C1, a drive power supply switch unit 320, a current detector 322, a drive current detection circuit 324, and a drive power supply control circuit 326.

Capacitor C1 is configured by connecting a plurality of electrolytic capacitor elements in series and/or in parallel. Capacitor C1 has a positive electrode terminal connected to a DC positive bus PL1, and a negative electrode terminal connected to a DC negative bus NL1.

Drive power supply switch unit 320 supplies drive current Id1 to opening coil 42 using power stored in capacitor C1. Drive power supply switch unit 320 has a switch for controlling supply and stop of drive current Id1. Turning on and off of this switch is controlled by drive power supply control circuit 326. By turning on the switch, drive current Id1 is supplied from capacitor C1 to opening coil 42. By turning off the switch, supply of drive current Id1 to opening coil 42 is stopped.

Current detector 322 is provided to DC positive bus PL1 or DC negative bus NL1 between drive power supply switch unit 320 and opening coil 42 to detect drive current Id1 flowing to opening coil 42.

Drive current detection circuit 324 receives a signal Id1f indicating a detection value of drive current Id1 from current detector 322, and provides received signal Id1f to charging control circuit 56.

Drive power supply control circuit 326 controls drive power supply switch unit 320 based on a power failure detection signal DET from power failure detection circuit 60. Power failure detection circuit 60 generates power failure detection signal DET based on AC voltage VI of input terminal T1. Power failure detection signal DET is set to an L (logic low) level when AC voltage VI supplied from commercial AC power supply 71 is normal, and is set to an H (logic high) level when AC voltage VI is not normal.

When power failure detection signal DET is at the L level, that is, when AC voltage VI supplied from commercial AC power supply 71 is normal, drive power supply control circuit 326 maintains the switch included in drive power supply switch unit 320 in an OFF state. By maintaining the switch in the OFF state, supply of drive current Id1 to opening coil 42 is in a stopped state.

When a momentary voltage drop occurs in commercial AC power supply 71 and power failure detection signal DET shifts from the L level to the H level, drive power supply control circuit 326 temporarily turns on the switch included in drive power supply switch unit 320. For a period in which the switch is set to an ON state, drive current Id1 is supplied to opening coil 42. Opening coil 42 converts electrical energy based on drive current Id1 into mechanical energy, and thereby opens mechanical contact 40 of mechanical switch 4. By opening mechanical contact 40, mechanical switch 4 is turned off. The ON period of the switch in drive power supply switch unit 320 is preset based on electrical energy needed by opening coil 42 to open mechanical contact 40.

Drive circuit 34 is a circuit for supplying drive current Id2 to closing coil 44. Drive circuit 34 includes a capacitor C2, a drive power supply switch unit 340, a current detector 342, a drive current detection circuit 344, and a drive power supply control circuit 346.

Capacitor C2 is configured by connecting a plurality of electrolytic capacitor elements in series and/or in parallel. Capacitor C2 has a positive electrode terminal connected to a DC positive bus PL2, and a negative electrode terminal connected to a DC negative bus NL2. DC positive bus PL2 is electrically connected to DC positive bus PL1. DC negative bus NL2 is electrically connected to DC negative bus NL1.

Drive power supply switch unit 340 supplies drive current Id2 to closing coil 44 using power stored in capacitor C2. Drive power supply switch unit 340 has a switch for controlling supply and stop of drive current Id2. Turning on and off of this switch is controlled by drive power supply control circuit 346. By turning on the switch, drive current Id2 is supplied from capacitor C2 to closing coil 44. By turning off the switch, supply of drive current Id2 to closing coil 44 is stopped.

Current detector 342 is provided to DC positive bus PL2 or DC negative bus NL2 between drive power supply switch unit 340 and closing coil 44 to detect drive current Id2 flowing to closing coil 44.

Drive current detection circuit 344 receives a signal Id2f indicating a detection value of drive current Id2 from current detector 342, and provides received signal Id2f to charging control circuit 56.

Drive power supply control circuit 346 controls drive power supply switch unit 340 based on power failure detection signal DET from power failure detection circuit 60.

When power failure detection signal DET is at the H level, drive power supply control circuit 346 maintains the switch included in drive power supply switch unit 340 in an OFF state. By maintaining the switch in the OFF state, supply of drive current Id2 to closing coil 44 is in a stopped state.

When power failure detection signal DET shifts from the H level to the L level, drive power supply control circuit 346 temporarily turns on the switch included in drive power supply switch unit 340. For a period in which the switch is set to an ON state, drive current Id2 is supplied to closing coil 44. Closing coil 44 converts electrical energy based on drive current Id2 into mechanical energy, and thereby closes mechanical contact 40 of mechanical switch 4. By closing mechanical contact 40, mechanical switch 4 is turned on. The ON period of the switch in drive power supply switch unit 340 is preset based on electrical energy needed by closing coil 44 to close mechanical contact 40.

Charging circuit 36 is a circuit for charging capacitor C1 of drive circuit 32 and capacitor C2 of drive circuit 34. By supplying drive current Id1 from drive circuit 32 to opening coil 42 to turn off mechanical switch 4, a charge amount stored in capacitor C1 decreases, and a terminal-to-terminal voltage of capacitor C1 (hereinafter simply referred to as a “voltage of capacitor C1”) decreases. By supplying drive current Id2 from drive circuit 34 to closing coil 44 to turn on mechanical switch 4, a charge amount stored in capacitor C2 decreases, and a terminal-to-terminal voltage of capacitor C2 (hereinafter simply referred to as a “voltage of capacitor C2”) decreases. Charging circuit 36 is controlled by charging control circuit 56, and supplies a charging current Ic to capacitors C1 and C2. Charging current Ic is a constant current.

Charging circuit 36 has a first charging mode in which it supplies charging current Ic to capacitor C1 and charges capacitor C1, a second charging mode in which it supplies charging current Ic to capacitor C2 and charges capacitor C2, and a third charging mode in which it supplies charging current Ic to capacitors C1 and C2 and charges capacitors C1 and C2. Switching among the charging modes will be described in detail later.

Current detector 50 detects charging current Ic flowing from charging circuit 36 to the corresponding capacitor(s) in each of the first to third charging modes.

Charging current detection circuit 52 receives a signal Icf indicating a detection value of charging current Ic from current detector 50, and provides received signal Icf to charging control circuit 56.

Charging voltage detection circuit 54 detects instantaneous values of a DC voltage V1 of DC positive bus PL1 and a DC voltage V2 of DC positive bus PL2, and provides signals V1f and V2f indicating detection values thereof to charging control circuit 56. DC voltage V1 of DC positive bus PL1 corresponds to the voltage of capacitor C1. DC voltage V2 of DC positive bus PL2 corresponds to the voltage of capacitor C2.

Charging control circuit 56 controls charging circuit 36 based on output signal Icf of charging current detection circuit 52, output signals V1f and V2f of charging voltage detection circuit 54, output signals Id1f and Idf of drive current detection circuit 324 and 344, and power failure detection signal DET.

In an aspect, in response to stop of supply of drive current Id1 to opening coil 42, that is, in response to turning-off of the switch included in drive power supply switch unit 320, charging control circuit 56 controls charging circuit 36 to charge capacitor C1. Specifically, in response to lapse of the ON period of the switch since a time point at which power failure detection signal DET shifted from the L level to the H level, charging control circuit 56 controls charging circuit 36 to perform the first charging mode. When a charge is stored in capacitor C1 by receiving supply of charging current Ic, and voltage V1 of capacitor C1 reaches a predetermined upper limit value VH, charging control circuit 56 controls charging circuit 36 to stop supply of charging current Ic to capacitor C1.

In another aspect, in response to stop of supply of drive current Id2 to closing coil 44, that is, in response to turning-off of the switch included in drive power supply switch unit 340, charging control circuit 56 controls charging circuit 36 to charge capacitor C2. Specifically, in response to lapse of the ON period of the switch since a time point at which power failure detection signal DET shifted from the H level to the L level, charging control circuit 56 controls charging circuit 36 to perform the second charging mode. When a charge is stored in capacitor C2 by receiving supply of charging current Ic, and voltage V2 of capacitor C2 reaches upper limit value VH, charging control circuit 56 controls charging circuit 36 to stop supply of charging current Ic to capacitor C2.

It should be noted that, when both voltage V1 of capacitor C1 and voltage V2 of capacitor C2 do not reach upper limit value VH, charging control circuit 56 controls charging circuit 36 to perform the third charging mode. When a charge is stored in capacitors C1 and C2 by receiving supply of charging current Ic, and voltages V1 and V2 of capacitors C1 and C2 reach upper limit value VH, charging control circuit 56 controls charging circuit 36 to stop supply of charging current Ic to capacitors C1 and C2.

Charging control circuit 56 includes a diagnosis circuit 58 for diagnosing degradation states of capacitors C1 and C2. Diagnosis circuit 58 diagnoses the degradation states of capacitors C1 and C2 based on output signal Icf of charging current detection circuit 52 and output signals V1f and V2f of charging voltage detection circuit 54. Diagnosis circuit 58 will be described in detail later.

It should be noted that the function of each block of drive current detection circuit 324 and drive power supply control circuit 326 in drive circuit 32, drive current detection circuit 344 and drive power supply control circuit 346 in drive circuit 34, charging current detection circuit 52, charging voltage detection circuit 54, and charging control circuit 56 shown in FIG. 3 can be implemented by at least one of software processing and hardware processing by controller 23 (FIG. 1).

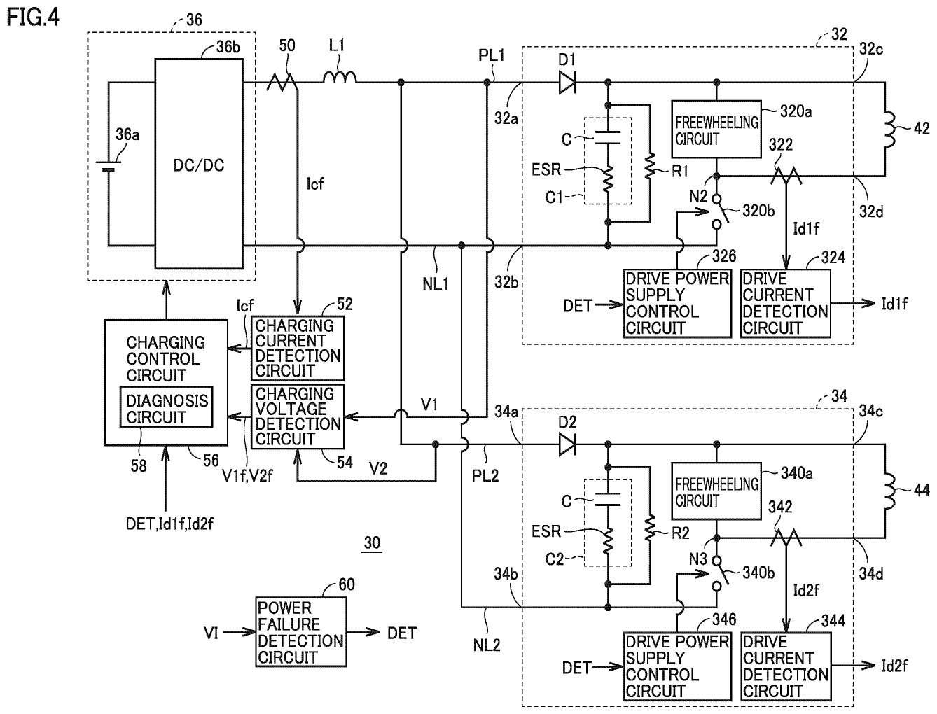

FIG. 4 is a circuit diagram showing an exemplary circuit configuration of drive circuits 32 and 34 and charging circuit 36 shown in FIG. 3.

As shown in FIG. 4, drive circuit 32 is configured to include a positive-side input terminal 32a, a negative-side input terminal 32b, a positive-side output terminal 32c, a negative-side output terminal 32d, a diode D1, capacitor C1, a discharging resistor R1, a freewheeling circuit 320a, and a switch 320b.

Positive-side input terminal 32a is connected to DC positive bus PL1, and negative-side input terminal 32b is connected to DC negative bus NL1. Opening coil 42 is connected between positive-side output terminal 32c and negative-side output terminal 32d.

Diode D1 is connected between positive-side input terminal 32a and the positive electrode terminal of capacitor C1. Diode D1 is a diode for preventing backflow.

Capacitor C1 can be represented by a series circuit of a capacitance C and an equivalent series resistance (ESR) which is a resistance component. It should be noted that an electrolytic capacitor has a characteristic that, as degradation proceeds, capacitance C decreases and the ESR increases.

Discharging resistor R1 is connected between the positive electrode terminal and the negative electrode terminal of capacitor C1. Discharging resistor R1 is provided to discharge the charge charged in capacitor C1 when drive circuit 32 is electrically cut off from opening coil 42 and charging circuit 36.

Freewheeling circuit 320a and switch 320b are connected in series between the positive electrode terminal and the negative electrode terminal of capacitor C1. Freewheeling circuit 320a and switch 320b constitute drive power supply switch unit 320 shown in FIG. 3. A node N2 between freewheeling circuit 320a and switch 320b is connected to negative-side output terminal 32d.

Switch 320b is the switch for controlling supply and stop of drive current Id1. Turning on and off of switch 320b is controlled by drive power supply control circuit 326. By turning on switch 320b, drive current Id1 is supplied from capacitor C1 to opening coil 42. Current detector 322 is interposed between negative-side output terminal 32d and node N2 to detect drive current Id1. By turning off switch 320b, supply of drive current Id1 to opening coil 42 is stopped.

Freewheeling circuit 320a is a circuit for protecting drive circuit 32 from a surge voltage generated when switch 320b is turned off to stop supply of drive current Id1 to opening coil 42. Freewheeling circuit 320a is, for example, a diode having a cathode electrically connected to positive-side output terminal 32c, and an anode electrically connected to negative-side output terminal 32d.

Drive circuit 34 has the same configuration as that of drive circuit 32. Specifically, drive circuit 34 is configured to include a positive-side input terminal 34a, a negative-side input terminal 34b, a positive-side output terminal 34c, a negative-side output terminal 34d, a diode D2, capacitor C2, a discharging resistor R2, a freewheeling circuit 340a, and a switch 340b.

Positive-side input terminal 34a is connected to DC positive bus PL2, and negative-side input terminal 34b is connected to DC negative bus NL2. Closing coil 44 is connected between positive-side output terminal 34c and negative-side output terminal 34d.

Diode D2 is connected between positive-side input terminal 34a and the positive electrode terminal of capacitor C2. Diode D2 is a diode for preventing backflow.

Discharging resistor R2 is connected between the positive electrode terminal and the negative electrode terminal of capacitor C2. Discharging resistor R2 is provided to discharge the charge charged in capacitor C2 when drive circuit 34 is electrically cut off from closing coil 44 and charging circuit 36.

Freewheeling circuit 340a and switch 340b are connected in series between the positive electrode terminal and the negative electrode terminal of capacitor C2. Freewheeling circuit 340a and switch 340b constitute drive power supply switch unit 340 shown in FIG. 3. A node N3 between freewheeling circuit 340a and switch 340b is connected to negative-side output terminal 34d.

Switch 340b is the switch for controlling supply and stop of drive current Id2. Turning on and off of switch 340b is controlled by drive power supply control circuit 346. By turning on switch 340b, drive current Id2 is supplied from capacitor C2 to closing coil 44. Current detector 342 is interposed between negative-side output terminal 34d and node N3 to detect drive current Id2. By turning off switch 340b, supply of drive current Id2 to closing coil 44 is stopped.

Freewheeling circuit 340a is a circuit for protecting drive circuit 34 from a surge voltage generated when switch 340b is turned off to stop supply of drive current Id2 to closing coil 44. Freewheeling circuit 340a is, for example, a diode having a cathode electrically connected to positive-side output terminal 34c, and an anode electrically connected to negative-side output terminal 34d.

Charging circuit 36 includes a battery 36a and a DC/DC converter 36b. DC/DC converter 36b is controlled by charging control circuit 56, and generates charging current Ic based on DC power of battery 36a. DC/DC converter 36b outputs an output voltage according to a lower voltage of voltages V1 and V2. Since drive circuits 32 and 34 are provided with diodes D1 and D2 for preventing backflow, charging current Ic is supplied only to a capacitor having the lower voltage. It should be noted that, when voltages V1 and V2 are equal to each other, charging current Ic is supplied to capacitors C1 and C2. In this case, charging current Ic supplied to each capacitor is about half of charging current Ic supplied only to a single capacitor.

By control of the output voltage in DC/DC converter 36b as described above and by diodes D1 and D2 for preventing backflow, charging circuit 36 can automatically switch among the first charging mode, the second charging mode, and the third charging mode, according to voltages V1 and V2.

A DC reactor L1 is interposed into DC positive bus PL1 between DC/DC converter 36b and drive circuit 32 to smooth a DC current supplied from DC/DC converter 36b.

### <Operation of Drive Power Supply>

Next, operation of drive power supply 30 in accordance with the first embodiment will be described.

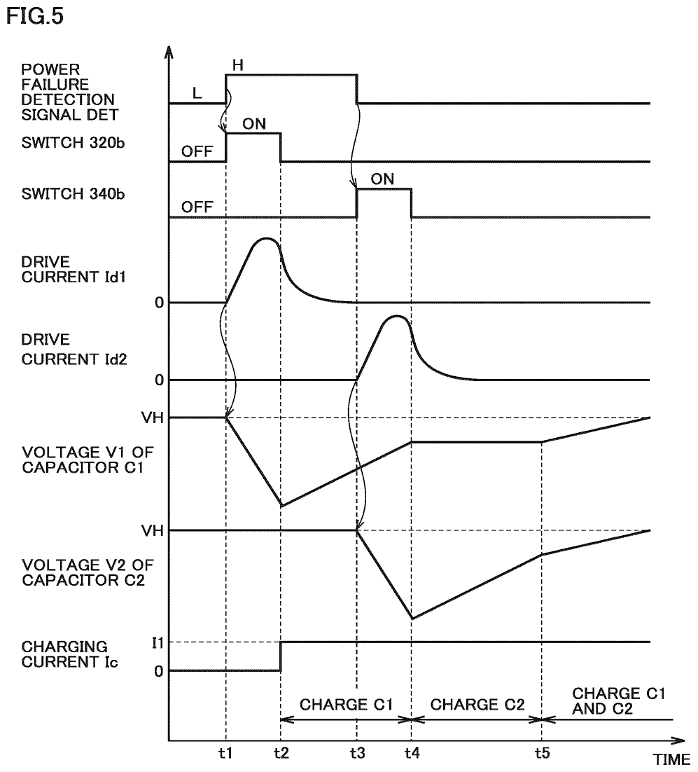

FIG. 5 is a view for describing operation of drive power supply 30. FIG. 5 shows a waveform indicating a temporal change of each of power failure detection signal DET, switches 320b and 340b, drive currents Id1 and Id2, voltages V1 and V2 of capacitors C1 and C2, and charging current Ic.

As shown in FIG. 5, a momentary voltage drop occurs in commercial AC power supply 71 at a time instant t1, and thereby power failure detection signal DET shifts from the L level to the H level. In drive circuit 32, drive power supply control circuit 326 temporarily turns on switch 320b in response to shift of power failure detection signal DET from the L level to the H level. In FIG. 5, switch 320b is set to the ON state for a period from time instant t1 to a time instant t2.

In the ON period of switch 320b, drive current Id1 is supplied from drive circuit 32 to opening coil 42. Opening coil 42 converts electrical energy based on drive current Id1 into mechanical energy, and thereby opens mechanical contact 40 of mechanical switch 4. By opening mechanical contact 40, mechanical switch 4 is turned off.

Before time instant t1, voltage V1 of capacitor C1 is maintained at predetermined upper limit value VH. Voltage V1 of capacitor C1 is proportional to the charge amount stored in capacitor C1. Upper limit value VH is set based on a charge amount needed to supply drive current Id1 to opening coil 42 in the ON period of switch 320b.

In the period from time instant t1 to time instant t2, as drive current Id1 is supplied, the charge amount stored in capacitor C1 decreases, and thus voltage V1 of capacitor C1 decreases. In response to turning-off of switch 320b at time instant t2, charging control circuit 56 controls charging circuit 36 to charge capacitor C1. DC/DC converter 36b included in charging circuit 36 outputs an output voltage according to voltage V1, which is a lower voltage of voltages V1 and V2, and thereby charging current Ic is supplied to capacitor C1. Thereby, after time instant t2, the charge is stored in capacitor C1 and voltage V1 gradually increases. It should be noted that, since charging current Ic is a constant current (with a current value I1), voltage V1 linearly increases.

Commercial AC power supply 71 recovers at a time instant t3, and thereby power failure detection signal DET shifts from the L level to the H level. In drive circuit 34, drive power supply control circuit 346 temporarily turns on switch 340b in response to shift of power failure detection signal DET from the H level to the L level. In FIG. 5, switch 340b is set to the ON state for a period from time instant t3 to a time instant t4. In the ON period of switch 340b, drive current Id2 is supplied from drive circuit 34 to closing coil 44. Closing coil 44 converts electrical energy based on drive current Id2 into mechanical energy, and thereby closes mechanical contact 40 of mechanical switch 4. By closing mechanical contact 40, mechanical switch 4 is turned on.

Before time instant t3, voltage V2 of capacitor C2 is maintained at upper limit value VH. In the period from time instant t3 to time instant t4, as drive current Id2 is supplied, the charge amount stored in capacitor C2 decreases, and thus voltage V2 of capacitor C2 decreases. In response to turning-off of switch 340b at time instant t4, charging control circuit 56 controls charging circuit 36 to charge capacitor C2.

In the example in FIG. 5, both voltage V1 and V2 do not reach upper limit value VH at time instant t4, and thus charging control circuit 56 controls charging circuit 36 to charge capacitors C1 and C2. Specifically, DC/DC converter 36b included in charging circuit 36 outputs an output voltage according to a lower voltage of voltages V1 and V2. Since voltage V2 is lower than voltage V1, after time instant t4, charging current Ic is supplied only to capacitor C2. Thereby, the charge is stored in capacitor C2 and voltage V2 gradually increases. On the other hand, after time instant t4, supply of charging current Ic to capacitor C1 is stopped, and thus voltage V1 maintains a value at time instant t4.

When voltage V2 increases and becomes equal to voltage V1 (at a time instant t5), charging circuit 36 supplies charging current Ic to capacitors C1 and C2. After time instant t5, the charge is stored in capacitors C1 and C2 and thereby voltages V1 and V2 gradually increase. When voltages V1 and V2 reach upper limit value VH, charging control circuit 56 stops charging circuit 36 and thereby stops supply of charging current Ic.

As described above, drive power supply 30 supplies drive currents Id1 and Id2 from capacitors C1 and C2 to coils 42 and 44, respectively, to open or close mechanical contact 40, and thereby turns on or off mechanical switch 4. Then, after turning on or off mechanical switch 4, drive power supply 30 supplies charging current Ic from charging circuit 36 to capacitors C1 and C2 to charge capacitors C1 and C2 such that capacitors C1 and C2 store power for driving mechanical switch 4 on a next occasion.

During charging of capacitors C1 and C2, diagnosis circuit 58 diagnoses the degradation states of capacitors C1 and C2 based on charging current Ic detected by charging current detection circuit 52, and voltages V1 and V2 of capacitors C1 and C2 detected by charging voltage detection circuit 54.

### (Diagnosis of Degradation of Capacitor)

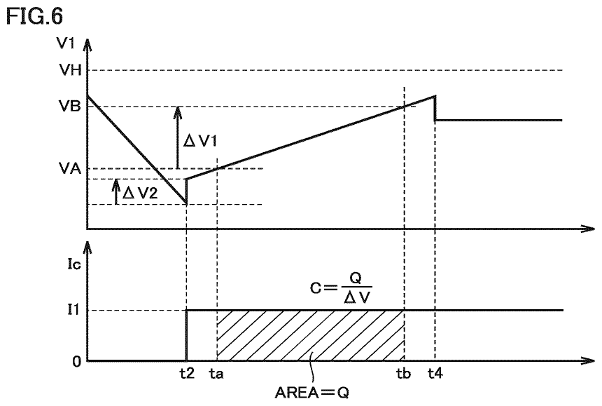

FIG. 6 is a view for describing a first example of processing for diagnosing degradation of a capacitor in diagnosis circuit 58. FIG. 6 shows partially extracted waveforms of voltage V1 of capacitor C1 and charging current Ic shown in FIG. 5. Processing for diagnosing degradation of capacitor C1 will be described using FIG. 6.

As shown in FIG. 6, before time instant t2, as drive current Id1 is supplied, the charge amount stored in capacitor C1 decreases, and thus voltage V1 of capacitor C1 decreases. At time instant t2, charging circuit 36 starts supply of charging current Ic to capacitor C1. After time instant t2, charging circuit 36 is controlled by charging control circuit 56, and supplies charging current Ic having constant value I1 to capacitor C1.

At time instant t2 when supply of charging current Ic is started, voltage V1 of capacitor C1 changes by ΔV2. This change amount ΔV2 is caused by a change in the magnitude of a current flowing to the ESR of capacitor C1.

In a period from time instant t2 to time instant t4, voltage V1 linearly increases. Diagnosis circuit 58 detects a value VA of voltage V1 at a time instant ta after time instant t2, based on output signal V1f of charging voltage detection circuit 54. Time instant ta corresponds to a measurement start time point for diagnosis. VA corresponds to voltage V1 of capacitor C1 at the measurement start time point (hereinafter also referred to as a “measurement start voltage”). It should be noted that a time difference between time instant t2 and time instant ta is about several milliseconds, and is set such that the result of measurement does not include fluctuations in voltage V1 due to the ESR.

Diagnosis circuit 58 adds a predetermined amount ΔV1 to VA, and sets VB, which is the result of the addition, as voltage VI of capacitor C1 at a measurement end time point (hereinafter also referred to as a “measurement end voltage”) (VB=VA+ΔV1). Predetermined amount ΔV1 is set, for example, to have a magnitude of about ½ to ⅓ of a rated voltage of capacitor C1. This is set such that the result of measurement does not include fluctuations in voltage V1 due to the ESR when supply of charging current Ic is stopped. Predetermined amount ΔV1 corresponds to one embodiment of a “first amount”.

Diagnosis circuit 58 detects a time instant tb at which voltage V1 reaches measurement end voltage VB, based on output signal V1f of charging voltage detection circuit 54. Time instant tb corresponds to the measurement end time point.

Next, diagnosis circuit 58 detects charging current Ic in a measurement period from measurement start time point ta to measurement end time point tb, based on output signal Icf of charging current detection circuit 52. Then, diagnosis circuit 58 integrates charging current Ic in the measurement period to calculate a charge amount Q stored in capacitor C1 in the measurement period. In the example in FIG. 6, since charging current Ic has constant value I1, charge amount Q is expressed as Q=I1×(tb−ta). It should be noted that charge amount Q corresponds to the area of a portion surrounded by time instant ta and time instant tb in the waveform of charging current Ic.

Diagnosis circuit 58 divides calculated charge amount Q by a change amount of voltage V1 (predetermined amount ΔV1) in the measurement period, to determine capacitance C of capacitor C1 (C=Q/ΔV1). Then, diagnosis circuit 58 diagnoses the degradation state of capacitor C1 based on determined capacitance C. An electrolytic capacitor generally has a characteristic that capacitance C decreases due to degradation. Diagnosis circuit 58 diagnoses the degradation state of capacitor C1 based on, for example, a change amount of capacitance C at present with respect to capacitance C when capacitor C1 is in an initial state.

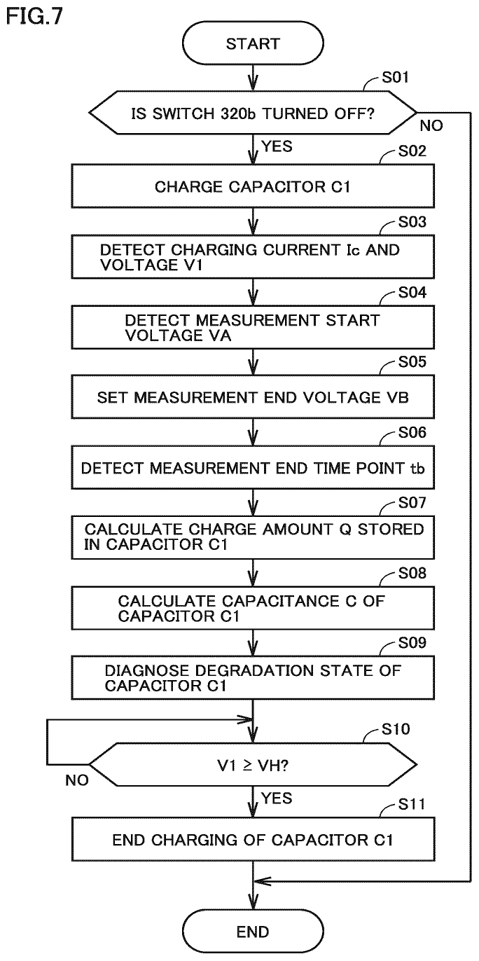

FIG. 7 is a flowchart showing the processing for diagnosing degradation of a capacitor in drive power supply 30 in accordance with the first embodiment. The flowchart in FIG. 7 is repeatedly performed during operation of drive power supply 30, at a control cycle predetermined by charging control circuit 56 in controller 23. FIG. 7 shows a procedure for the processing for diagnosing degradation of capacitor C1. Charging control circuit 56 also performs processing for diagnosing degradation of capacitor C2 in parallel, by following the same procedure as that in FIG. 7.

As shown in FIG. 7, charging control circuit 56 determines, by step (hereinafter simply denoted as “S”) 01, whether or not switch 320b included in drive power supply switch unit 320 of drive circuit 32 is turned off. In S01, it is determined as YES when the ON period of switch 320b has elapsed since the time point at which power failure detection signal DET shifted from the L level to the H level, and it is determined as NO when power failure detection signal DET is at the L level or the H level, or when the ON period has not elapsed.

When it is determined that switch 320b is turned off (when it is determined as YES in S01), charging control circuit 56 proceeds to S02, and controls charging circuit 36 to charge capacitor C1. In S02, DC/DC converter 36b included in charging circuit 36 outputs an output voltage according to voltage V1, which is a lower voltage of voltages V1 and V2, and thereby charging current Ic is supplied to capacitor C1.

During charging of capacitor C1, by S03, charging control circuit 56 detects charging current Ic and voltage V1 of capacitor C1 based on the output signals of charging current detection circuit 52 and charging voltage detection circuit 54.

By S04, diagnosis circuit 58 detects voltage V1 at measurement start time point ta after a charging start time instant of capacitor C1, and sets a detection value thereof as measurement start voltage VA. Subsequently, by S05, diagnosis circuit 58 adds predetermined amount ΔV1 to measurement start voltage VA to set measurement end voltage VB.

By S06, diagnosis circuit 58 detects measurement end time point tb at which voltage V1 reaches measurement end voltage VB. By S07, diagnosis circuit 58 integrates charging current Ic in the period from measurement start time point ta to measurement end time point tb, to calculate charge amount Q stored in capacitor C1 in the period.

By S08, diagnosis circuit 58 divides calculated charge amount Q by predetermined amount ΔV1, to determine capacitance C of capacitor C1 (C=Q/ΔV1). By S09, diagnosis circuit 58 diagnoses the degradation state of capacitor C1 based on capacitance C determined in S07.

By S10, charging control circuit 56 determines whether or not voltage V1 of capacitor C1 is more than or equal to upper limit value VH. In the case of V1<VH (when it is determined as NO in S10), charging control circuit 56 continuously performs charging of capacitor C1.

In the case of V1≥VH (when it is determined as YES in S10), by S11, charging control circuit 56 controls charging circuit 36 to stop supply of charging current Ic to capacitor C1, and thereby ends charging of capacitor C1.

As described above, in drive power supply 30 in accordance with the first embodiment, during charging of capacitors C1 and C2 included in drive power supply 30 for mechanical switch 4, the degradation states of capacitors C1 and C2 are diagnosed from charging current Ic detected by charging current detection circuit 52, and voltages V1 and V2 of capacitors C1 and C2 detected by charging voltage detection circuit 54. Thus, since the degradation states of capacitors C1 and C2 can be diagnosed utilizing charging circuit 36 and charging control circuit 56 already provided in drive power supply 30, it is not necessary to mount a dedicated degradation diagnosis device on the multiple power compensator. Therefore, the degradation states of capacitors C1 and C2 can be diagnosed with a downsized configuration.

### Second Embodiment

The first embodiment described above has described the configuration of diagnosing the degradation states of capacitors C1 and C2 from charging current Ic and voltages V1 and V2 of capacitors C1 and C2, when capacitors C1 and C2 are charged in preparation for driving mechanical switch 4 by drive power supply 30 on the next occasion.

In the configuration described above, since relatively large charging current Ic is supplied to each capacitor, the voltage of each capacitor that receives charging current Ic changes significantly. Accordingly, influence of a detection error caused by charging current detection circuit 52 and charging voltage detection circuit 54 is reduced, and as a result, the capacitance of each capacitor can be calculated with high accuracy. Further, since degradation diagnosis is conducted every time capacitors C1 and C2 are charged, it is possible to detect rapid degradation of capacitors C1 and C2 due to a spark produced during discharging of capacitors C1 and C2.

On the other hand, however, in a situation where the frequency at which a momentary voltage drop occurs in commercial AC power supply 71 is low, the frequency at which drive power supply 30 drives mechanical switch 4 becomes low. Accordingly, in the configuration described in the first embodiment, the frequency at which diagnosis of degradation of capacitors C1 and C2 is conducted also becomes low. In such a case, there is a concern that it may be difficult to detect temporal degradation of capacitors C1 and C2. Even under the situation where the frequency at which a momentary voltage drop occurs in commercial AC power supply 71 is low, it is required to periodically diagnose the degradation states of capacitors C1 and C2, in order to secure charge storage ability of capacitors C1 and C2 in preparation for occurrence of a momentary voltage drop.

Accordingly, a second embodiment will describe a configuration of periodically diagnosing the degradation states of capacitors C1 and C2 in a standby state of drive power supply 30. It should be noted that the configuration of drive power supply 30 in accordance with the second embodiment is the same as the configuration of drive power supply 30 shown in FIGS. 3 and 4 except for the configuration of diagnosis circuit 58, and thus the description will be omitted.

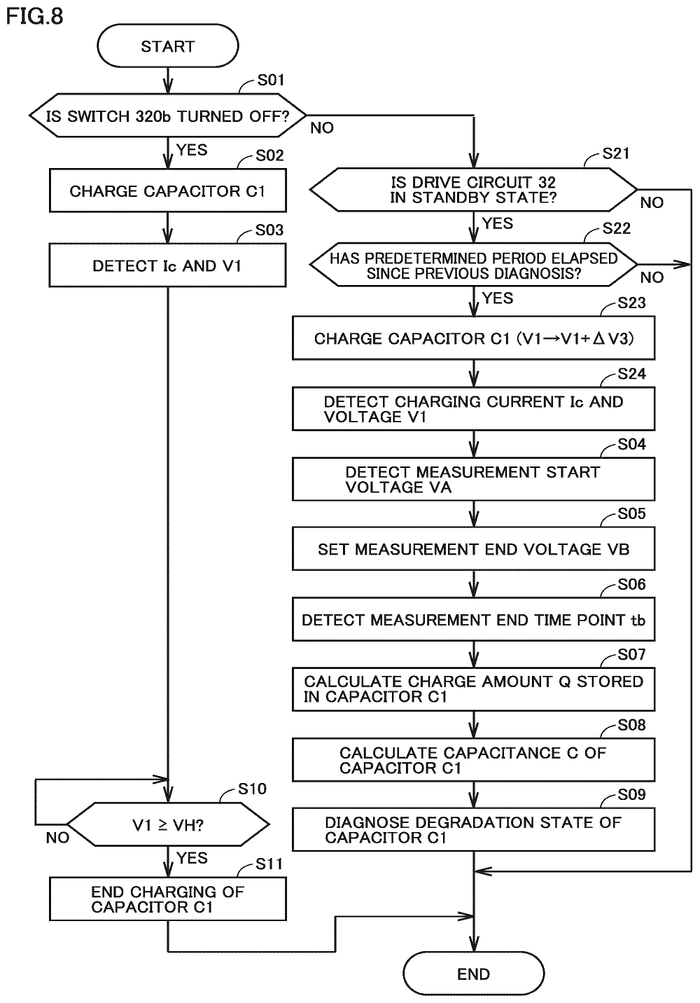

FIG. 8 is a flowchart showing processing for diagnosing degradation of a capacitor in drive power supply 30 in accordance with the second embodiment. The flowchart in FIG. 8 is repeatedly performed during normal operation of the multiple power compensator shown in FIG. 1, at a control cycle predetermined by charging control circuit 56 in controller 23. FIG. 8 shows a procedure for processing for diagnosing degradation of capacitor C1. Charging control circuit 56 also performs processing for diagnosing degradation of capacitor C2 in parallel, by following the same procedure as that in FIG. 8.

As shown in FIG. 8, charging control circuit 56 determines, by S01 which is the same as that in FIG. 7, whether or not switch 320b included in drive power supply switch unit 320 of drive circuit 32 is turned off.

When it is determined that switch 320b is turned off (when it is determined as YES in S01), charging control circuit 56 proceeds to S02 which is the same as that in FIG. 7, and controls charging circuit 36 to charge capacitor C1. During charging of capacitor C1, by S03 which is the same as that in FIG. 7, charging control circuit 56 detects charging current Ic and voltage V1 of capacitor C1 based on the output signals of charging current detection circuit 52 and charging voltage detection circuit 54.

By S10 which is the same as that in FIG. 7, charging control circuit 56 determines whether or not voltage V1 of capacitor C1 is more than or equal to upper limit value VH. In the case of V1<VH (when it is determined as NO in S10), charging control circuit 56 continuously performs charging of capacitor C1.

In the case of V1≥VH (when it is determined as YES in S10), by S11 which is the same as that in FIG. 7, charging control circuit 56 controls charging circuit 36 to stop supply of charging current Ic to capacitor C1, and thereby ends charging of capacitor C1.

Turning back to S01, when switch 320b is not turned off (when it is determined as NO in S01), charging control circuit 56 proceeds to S21, and determines whether or not drive circuit 32 is in a standby state. In S21, based on output signal V1f of charging voltage detection circuit 54, it is determined as YES when voltage V1 of capacitor C1 is more than or equal to upper limit value VH, and it is determined as NO when voltage V1 is less than upper limit value VH.

When drive circuit 32 is in the standby state (when it is determined as YES in S21), by S22, charging control circuit 56 determines whether or not a predetermined period has elapsed since a time point at which degradation of capacitor C1 was diagnosed on a previous occasion. In S22, charging control circuit 56 has a time measuring function, and measures an elapsed time since the time point at which degradation diagnosis was conducted on the previous occasion. When the elapsed time does not reach a predetermined period (for example, one month), it is determined as NO in S22. When the elapsed time reaches the predetermined period, it is determined as YES in S22.

When the predetermined period has elapsed since the time point at which diagnosis of degradation of capacitor C1 was conducted on the previous occasion (when it is determined as YES in S22), charging control circuit 56 proceeds to S23, and controls charging circuit 36 to charge capacitor C1. In S23, charging control circuit 56 charges capacitor C1 to increase voltage V1 of capacitor C1 by a predetermined amount ΔV3. Since voltage V1 of capacitor C1 is more than or equal to upper limit value VH when drive circuit 32 is in the standby state, capacitor C1 may be overcharged by the charging by S23. When capacitor C1 is overcharged, excessive drive current Id1 may be supplied to opening coil 42 during operation of drive circuit 32, and mechanical contact 40 may rebound. From the viewpoint of avoiding such a situation, predetermined amount ΔV3 is set to a voltage that is minute enough to have no influence on the operation of drive circuit 32. Predetermined amount ΔV3 corresponds to one embodiment of a “second amount”.

During charging of capacitor C1, by S24, charging control circuit 56 detects charging current Ic and voltage V1 of capacitor C1 based on the output signals of charging current detection circuit 52 and charging voltage detection circuit 54.

By S04 which is the same as that in FIG. 7, diagnosis circuit 58 detects voltage V1 at measurement start time point ta after the charging start time instant of capacitor C1, and sets a detection value thereof as measurement start voltage VA. Subsequently, by S05 which is the same as that in FIG. 7, diagnosis circuit 58 adds predetermined amount ΔV3 to measurement start voltage VA to set measurement end voltage VB.

By S06 which is the same as that in FIG. 7, diagnosis circuit 58 detects measurement end time point tb at which voltage V1 reaches measurement end voltage VB. By S07 which is the same as that in FIG. 7, diagnosis circuit 58 integrates charging current Ic in the period from measurement start time point ta to measurement end time point tb, to calculate charge amount Q stored in capacitor C1 in the period.

By S08 which is the same as that in FIG. 7, diagnosis circuit 58 divides calculated charge amount Q by predetermined amount ΔV3, to determine capacitance C of capacitor C1 (C=Q/ΔV3). By S09 which is the same as that in FIG. 7, diagnosis circuit 58 diagnoses the degradation state of capacitor C1 based on capacitance C determined in S07.

It should be noted that the processing for diagnosing degradation of capacitors C1 and C2 in accordance with the second embodiment can be performed in combination with the processing for diagnosing degradation of capacitors C1 and C2 in accordance with the first embodiment. That is, it is possible to provide a configuration that, when drive power supply 30 is in an operation state in which it drives mechanical switch 4, the processing for diagnosing degradation in accordance with the first embodiment is performed during charging of capacitors C1 and C2, and when drive power supply 30 is in the standby state, the processing for diagnosing degradation in accordance with the second embodiment is performed.

With such a configuration, the degradation states of capacitors C1 and C2 can be diagnosed appropriately, irrespective of the frequency of occurrence of a momentary voltage drop in commercial AC power supply 71. That is, in a situation where the frequency of occurrence of a momentary voltage drop in commercial AC power supply 71 is high, rapid degradation of capacitors C1 and C2 due to a spark during repeated discharging can be detected. Further, in a situation where the frequency of occurrence of a momentary voltage drop in commercial AC power supply 71 is low, temporal degradation of capacitors C1 and C2 can be detected.

### Third Embodiment

The first and second embodiments described above have described the configurations of calculating capacitance C of each capacitor in order to diagnose the degradation states of capacitors C1 and C2. A third embodiment will describe a configuration of calculating the ESR of each capacitor.

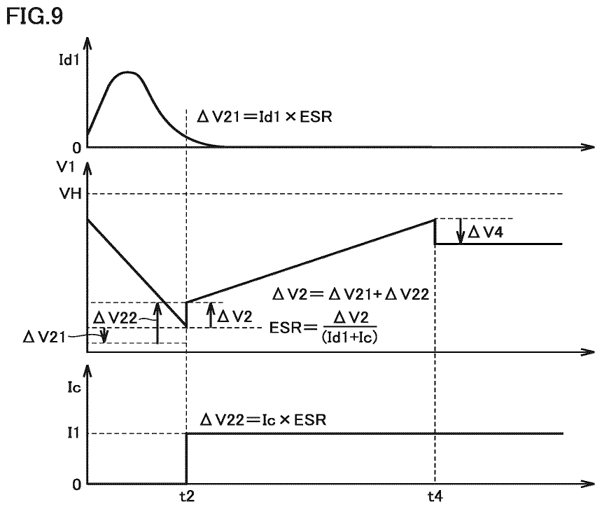

FIG. 9 is a view for describing a second example of the processing for diagnosing degradation of a capacitor in diagnosis circuit 58. FIG. 9 shows partially extracted waveforms of voltage V1 of capacitor C1, drive current Id1, and charging current Ic shown in FIG. 5. Processing for diagnosing degradation of capacitor C1 will be described using FIG. 9.

As shown in FIG. 9, before time instant t2, as drive current Id1 is supplied, the charge amount stored in capacitor C1 decreases, and thus voltage V1 of capacitor C1 decreases. At time instant t2, charging circuit 36 starts supply of charging current Ic to capacitor C1. After time instant t2, charging circuit 36 is controlled by charging control circuit 56, and supplies charging current Ic having constant value 11 to capacitor C1.

At time instant t2, voltage V1 of capacitor C1 changes by ΔV2. This change amount ΔV2 is caused by a change in the magnitude of the current flowing to the ESR of capacitor C1, due to stop of supply of drive current Id1 from capacitor C1 and start of supply of charging current Ic to capacitor C1.

That is, change amount ΔV2 is the sum of a change amount ΔV21 due to stop of supply of drive current Id1 and a change amount ΔV22 due to start of supply of charging current Ic (ΔV2=ΔV21+ΔV22). ΔV21 has a magnitude equal to the product of the ESR and the value of drive current Id1 (ESR×Id1). ΔV22 has a magnitude equal to the product of the ESR and value Il of charging current Ic (ESR×I1). ΔV21 corresponds to a decrease amount by which voltage V1 decreases, and ΔV22 corresponds to an increase amount by which voltage V1 increases.

Diagnosis circuit 58 detects change amount ΔV2 based on the output signal of charging voltage detection circuit 54, and divides detected change amount ΔV2 by the sum of drive current Id1 and charging current Ic to determine the ESR. It should be noted that drive current Id1 has a negative value and charging current Ic has a positive value.

Diagnosis circuit 58 diagnoses the degradation state of capacitor C1 based on determined capacitance C. An electrolytic capacitor generally has a characteristic that the ESR increases due to degradation. Diagnosis circuit 58 diagnoses the degradation state of capacitor C1 based on, for example, a change amount of the ESR at present with respect to the ESR when capacitor C1 is in an initial state.

It should be noted that, although FIG. 9 has described an exemplary configuration of calculating the ESR from increase amount ΔV3 of voltage V1 at time instant t2 at which supply of charging current Ic to capacitor C1 is started, the ESR may be calculated from a change amount ΔV4 of voltage V1 at time instant t4 at which supply of charging current Ic to capacitor C1 is stopped. ΔV4 has a magnitude equal to the product of the ESR and value I1 of charging current Ic (ESR×I1). ΔV4 corresponds to a decrease amount by which voltage V1 decreases.

It should be noted that, although the first to third embodiments described above have described exemplary configurations of the drive power supply that supplies the drive current to the mechanical switch included in the power supply device, the drive power supply in accordance with the present disclosure is applicable to not only a power supply device, but also any device including a mechanical switch. In every case where it is applied to any device, it can diagnose the degradation state of a capacitor included in the drive power supply without upsizing the device.

It should be understood that the embodiments disclosed herein are illustrative and non-restrictive in every respect. The scope of the present disclosure is defined by the scope of the claims, and is intended to include any modifications within the scope and meaning equivalent to the scope of the claims.

### REFERENCE SIGNS LIST

1, 5, 6, 21: VCB; 2: high-speed switch; 3: semiconductor switch; 4: mechanical switch; 7: power converter; 8: bidirectional converter; 9: fuse; 10, 50, 322, 342: current detector; 11: reactor; 12, C1, C2: capacitor, 20: transformer; 20a: primary winding; 20b: secondary winding; 22: operation unit; 23: controller; 30: drive power supply; 32, 34: drive circuit; 32a, 34b: positive-side input terminal; 32b, 34b: negative-side input terminal; 32c, 34c: positive-side output terminal; 32d, 34d: negative-side output terminal; 36: charging circuit; 36a: battery; 36b: DC/DC converter; 40: mechanical contact; 42: opening coil; 44: closing coil; 52: charging current detection circuit; 54: charging voltage detection circuit; 56: charging control circuit; 58: diagnosis circuit; 60: power failure detection circuit; 71: commercial AC power supply; 72: load; 73: power storage device; 230: CPU; 232: memory; 234: I/O circuit; 236: bus; 320, 340: drive power supply switch unit; 320a, 340a: freewheeling circuit, 320b, 340b: switch; 324, 344: drive current detection circuit; 326, 346: drive power supply control circuit; T1: input terminal; T2: output terminal; T3: DC terminal; PL1, PL2: DC positive bus; NL1, NL2: DC negative bus; L1: DC reactor; R1, R2: discharging resistor; D1, D2: diode; Id1, Id2: drive current; Ic: charging current; DET: power failure detection signal.

1. A drive power supply that supplies a drive current to a mechanical switch,
the mechanical switch including a mechanical contact, and a coil that receives supply of the drive current and opens or closes the mechanical contact,
the drive power supply comprising:
a capacitor;
a switch connected between the capacitor and the coil, the switch being configured to be temporarily turned on in order to turn on or off the mechanical switch, and to supply the drive current from the capacitor to the coil;
a charging circuit that charges the capacitor in an OFF period of the switch;
a detection circuit that detects a charging current and a voltage of the capacitor; and
a diagnosis circuit that diagnoses a degradation state of the capacitor from the charging current and the voltage detected by the detection circuit.

2. The drive power supply for the mechanical switch according to claim 1, wherein
the charging circuit charges the capacitor in the OFF period after the switch is temporarily turned on, and
during charging of the capacitor, the diagnosis circuit
integrates the charging current in a period in which the voltage of the capacitor increases by a first amount to calculate a charge amount stored in the capacitor in the period,
divides the calculated charge amount by the first amount to calculate the capacitance of a capacitor, and
diagnoses the degradation state of the capacitor based on the calculated capacitance.

3. The drive power supply for the mechanical switch according to claim 1, wherein
when a predetermined period has elapsed since a previous diagnosis in the OFF period of the switch, the charging circuit charges the capacitor to increase the voltage of the capacitor by a second amount, and
during charging of the capacitor, the diagnosis circuit
integrates the charging current in a period in which the voltage of the capacitor increases by the second amount to calculate a charge amount stored in the capacitor in the period,
divides the calculated charge amount by the second amount to calculate the capacitance of a capacitor, and
diagnoses the degradation state of the capacitor based on the calculated capacitance.

4. The drive power supply for the mechanical switch according to claim 1, wherein
the diagnosis circuit
calculates an equivalent series resistance of the capacitor from a change amount of the voltage based on the charging current at start or end of charging of the capacitor, and
diagnoses the degradation state of the capacitor based on the calculated equivalent series resistance.

5. A power supply device comprising:
a mechanical switch having a first terminal that receives an AC voltage supplied from an AC power supply, and a second terminal connected to a load;
a power converter connected between the second terminal of the mechanical switch and a power storage device;
a controller configured to turn on the mechanical switch when the AC power supply is normal, and to turn off the mechanical switch when the AC power supply is not normal; and
a drive power supply that receives an instruction from the controller and supplies a drive current to the mechanical switch,
the mechanical switch including a mechanical contact, and a coil that receives supply of the drive current and opens or closes the mechanical contact,
the drive power supply including:
a capacitor;
a switch connected between the capacitor and the coil, the switch being configured to be temporarily turned on in order to turn on or off the mechanical switch, and to supply the drive current from the capacitor to the coil;
a charging circuit that charges the capacitor in an OFF period of the switch;
a detection circuit that detects a charging current and a voltage of the capacitor; and
a diagnosis circuit that diagnoses degradation of the capacitor from the charging current and the voltage detected by the detection circuit.

6. A method for diagnosing degradation of a capacitor included in a drive power supply that supplies a drive current to a mechanical switch,
the mechanical switch including a mechanical contact, and a coil that receives supply of the drive current and opens or closes the mechanical contact,
the drive power supply including a capacitor, and a switch connected between the capacitor and the coil, and being configured to temporarily turn on the switch in order to turn on or off the mechanical switch, and to supply the drive current from the capacitor to the coil,
the method comprising:
charging the capacitor in an OFF period of the switch;
detecting a charging current and a voltage of the capacitor; and
diagnosing a degradation state of the capacitor from the charging current and the voltage.

7. The method for diagnosing degradation according to claim 6, wherein
the charging includes charging the capacitor in the OFF period after the switch is temporarily turned on, and
the diagnosing includes
integrating the charging current in a period in which the voltage of the capacitor increases by a first amount, during charging of the capacitor, to calculate a charge amount stored in the capacitor in the period,
dividing the calculated charge amount by the first amount to calculate the capacitance a capacitor, and
diagnosing the degradation state of the capacitor based on the calculated capacitance.

8. The method for diagnosing degradation according to claim 6, wherein
the charging includes charging the capacitor to increase the voltage of the capacitor by a second amount, when a predetermined period has elapsed since a previous diagnosis in the OFF period of the switch, and
the diagnosing includes
integrating the charging current in a period in which the voltage of the capacitor increases by the second amount, during charging of the capacitor, to calculate a charge amount stored in the capacitor in the period,
dividing the calculated charge amount by the second amount to calculate the capacitance of a capacitor, and
diagnosing the degradation state of the capacitor based on the calculated capacitance.

9. The method for diagnosing degradation according to claim 6, wherein
the diagnosing includes
calculating an equivalent series resistance of the capacitor from a change amount of the voltage based on the charging current at start or end of charging of the capacitor, and
diagnosing the degradation state of the capacitor based on the calculated equivalent series resistance.

10. The drive power supply for the mechanical switch according to claim 2, wherein
when a predetermined period has elapsed since a previous diagnosis in the OFF period of the switch, the charging circuit charges the capacitor to increase the voltage of the capacitor by a second amount, and
during charging of the capacitor, the diagnosis circuit
integrates the charging current in a period in which the voltage of the capacitor increases by the second amount to calculate a charge amount stored in the capacitor in the period,
divides the calculated charge amount by the second amount to calculate the capacitance of a capacitor, and
diagnoses the degradation state of the capacitor based on the calculated capacitance.

11. The method for diagnosing degradation according to claim 7, wherein
the charging includes charging the capacitor to increase the voltage of the capacitor by a second amount, when a predetermined period has elapsed since a previous diagnosis in the OFF period of the switch, and
the diagnosing includes
integrating the charging current in a period in which the voltage of the capacitor increases by the second amount, during charging of the capacitor, to calculate a charge amount stored in the capacitor in the period,
dividing the calculated charge amount by the second amount to calculate the capacitance of a capacitor, and
diagnosing the degradation state of the capacitor based on the calculated capacitance.
